(19) United States
(12) Patent Application Publication
(10) Pub. No.: US 2008/0028963 A1
(43) Pub. Date: Feb. 7, 2008

(54) COATED ROLLER

(76) Inventor: DIRK RICHTER, Duren (DE)

Correspondence Address: Henry M. Feiereisen;Henry M. Feiereisen, LLC, Suite 4714, 350 Fifth Avenue, New York, NY, 10118, US

(21) Appl. No.: 11/837,861

(22) Filed: Aug. 13, 2007

Related U.S. Application Data
(63) Continuation of application No. 11/246,011, filed on Oct. 7, 2005.
Application No. 11/246,011 is a continuation of application No. PCT/DE04/00759, filed on Apr. 13, 2004.

(30) Foreign Application Priority Data
Apr. 11, 2003 (DE) 103 17 025.1
Apr. 16, 2003 (DE) 103 17 840.6
Apr. 16, 2003 (DE) 103 17 841.4
Aug. 25, 2003 (DE) 103 39 443.5

(51) Int. Cl. B41L 27/16

(52) U.S. Cl. 101/348

(57) ABSTRACT

A roller has a coating comprised of a plastic matrix of plastic material, wherein the plastic material is a resin. The surface of the coating has less than 50 pores per m², and hard material particles are embedded in the plastic matrix

### CROSS-REFERENCES TO RELATED APPLICATIONS

This application is a continuation of prior filed copending U.S. application Ser. No. 11/246,011, filed Oct. 7, 2005, the priority of which is hereby claimed under 35 U.S.C. §120, and which is a continuation of prior International Application Number PCT/DE2004/000759, filed on Apr. 13, 2004, which claims the priority of German Patent Applications, Serial Nos. 103 17 025.1, filed Apr. 11, 2003; 103 17 840.6, filed Apr. 16, 2003; 103 17 841.4, filed Apr. 16, 2003; and 103 39 443.5, filed Aug. 25, 2003, pursuant to 35 U.S.C. 119(a)-(d).

The contents of U.S. application Ser. No. 11/246,011 and International Application Number PCT/DE2004/000759 are incorporated herein by reference in their entirety as if fully set forth herein.

### BACKGROUND OF THE INVENTION

The present invention relates to a method of coating a roller with a covering that is formed from at least two components and well as to an accordingly coated roller.

A roller coating method and an accordingly coated roller are known for example from WO 89/00507, granules of hard material being applied in a metallic matrix while causing the roller to be coated to rotate in a corresponding bath. Another coating method is shown in DE 693 14 966 T2. By this method, a press roller coating is made by impregnating a reinforcement material with a curing liquid including a filler such as mineral particles, synthetic particles or refractory particles such as an epoxy matrix and by spirally wounding said material around a roller.

It is the object of the invention to provide a high-quality, very uniform covering. Likewise, it is another object of the present invention to provide a correspondingly coated roller.

### SUMMARY OF THE INVENTION

The solution proposed by the invention is a method of coating a roller with a covering that is formed from at least two curing components by which the two components are mixed under anaerobic conditions or preferably under vacuum first and the resulting mixture is applied as a covering onto the roller next.

In this manner, the two components can be mixed with very high energy and quite quickly without air or any other gas being brought into the mixture that would have to be either removed or remain entrapped, thus reducing the quality of the roller covering. The mixing time can be shortened more specifically through the higher mixing energies such as a higher stirring speed, so that, with curing mixtures in particular, the working time for the actual application at the same degree of mixing increases, with the quality of the covering being accordingly enhanced.

The two components may more specifically be blended under vacuum. This permits to successfully prevent air from becoming entrapped already while one component is added to the other component so that the quality of the covering may be improved.

It is understood though that the vacuum needs not be maintained during the entire mixing or stirring process. Vacuum is only needed as long as there is a noteworthy risk of air becoming entrapped.

Advantageously, the vacuum intensity matches the stirring speed or the energy applied during mixing, with a small negative pressure at low stirring speeds being already sufficient to prevent air or gas bubbles from becoming entrapped. Under given circumstances, the need for a negative pressure can be obviated, in particular during mixing, if the two components are sufficiently degassed and if air is prevented from being brought into the mixture during mixing. The mixing process may for example take place in a space in which there is no air at all.

Inasmuch, this method differs from the method of manufacturing a doctor bed assembly disclosed in DE 101 20 786 A1 in which two plastic components are mixed with a crosslinking agent being added thereto in a mixing head, the one plastic component being degassed first and the mixture being degassed again after the second plastic component has been stirred in and being then allowed to rest for more than 30 minutes. In the present method, the components are also mixed under vacuum in accordance with that invention.

Accordingly, the invention also proposes a roller having a coating comprised of plastic material that features, on the surface of the coating, less than 50 visible pores per m². Such a design is only possible if the components forming the plastic material are mixed under vacuum since longer stirring or degassing times are not possible because of the curing process induced by a crosslinking agent and/or by a curing agent. It has been found that such a roller coating is extremely stable. More specifically, such type pores need not be closed at a later stage, which would destabilize the covering anyway.

If the method is conducted in a suited manner, in particular if the stirring speed and the vacuum are sufficiently high, it is also possible to obtain a coating having less than 20 or 10 or even 5 visible pores per m².

Intensive stirring allows for breaking the pores and reducing them below the limits of visibility. Still, a corresponding quantity of air or of any other gas is entrapped in the covering, impairing its quality. Accordingly, the present invention seeks protection for a covering comprising less entrapped gas through fine pores or inner surfaces as they are obtained in a covering having 50 or 20, 10 or even 5 visible pores per m².

It is understood that a thus configured coating surface is also indicative of a corresponding quality of the coating itself, which accordingly also features over its coating thickness a very small number of pores or of entrapped air or gas bubbles, which in turn entails an extremely stable coating.

The method is more specifically suited for coverings including resins such as epoxy resins and/or in which one component is blended with a curing agent used as the second component before they cure within a short period of time. At least one component can comprise fibers that are intended to reinforce the finished covering or hard materials such as hard metals or ceramics. Air or gas can become entrapped very easily in such type corrective substances if components are blended with such type corrective substances.

Diamond dust or diamond powder are particularly contemplated for use as a corrective substance as they permit to provide good wear protection. This diamond dust or this diamond powder can be applied in a matrix, preferably made from plastic, onto the roller. Whilst the use of diamond dust or powder is known to be used as an abrasive, this covering, which can also be applied onto a roller at a later stage, provides outstanding wear protection for a roller body i.e., in particular for a body that is not intended to act as a removing body.

Cubic boron nitride or any other noble hard material or other particles of noble hard material as well as combinations of particles of noble hard material may be used instead of diamond dust or powder. These include in particular metallic noble hard materials and non-metallic noble hard materials, with the non-metallic noble hard materials being preferred. As contrasted with the document DE 693 14 966 T2 in which the plastic matrix contains filling material that may also include mineral particles, with this printed document only mentioning feldspar particles, or aluminium oxide, which is already to be found in roller coatings as a conventional, simple and above all low cost hard material, the present choice of hard material or hard material particles provides a completely different type of roller coating.

In the present coating, the hardness difference between the hard material particles and the plastic matrix holding these particles is of several orders of magnitude as contrasted with the coating according to DE 693 14 966 T2 or with coatings with hard material particles in a metallic matrix as they are for example disclosed in WO 89/00507 A1. The combination of these materials however leads to roller coverings exhibiting surprisingly outstanding properties; for these are extremely resistant, both against abrasion and against high pressure load. The actually soft and elastic bedding of the hard material particles has been hypothesized to be responsible therefore.

Moreover, such type coatings can be applied at room temperature, which considerably facilitates manufacturing.

The mixture of hard material particles and plastic material can be applied to the roller in any suited manner. A spiral application pattern appears to be particularly advantageous.

There may be provided on the one side a coating apparatus that is displaceable along an axis of the roller and that includes an application blade connected to a reservoir and at least one wiping blade trailing behind the application blade and on the other side a coating apparatus that is displaceable along an axis of the roller and that includes an application blade connected to a reservoir and at least one smoothing blade trailing behind the application blade, these apparatus being then displaced accordingly.

The trailing wiping blade thereby permits to remove the excess material and to spread it over other regions with less material. Moreover, excess material can also be carried away and an overflow can be preferably provided for this purpose.

Preferably, the wiping blade moves in a direction counter to its direction of movement away from the roller so that the distance between the wiping blade and the roller progressively increases while the wiping blade is being guided along the roller. The increase can be gradual or continuous. Thus, material that possibly protrudes or accumulates through flowing or curing behind the application blade can be wiped off and spread out again onto the roller or carried away through a possibly provided overflow.

The actual diameter of the coated roller may increase as compared to a desired diameter as a result thereof. In particular with high-cost materials, this is generally not critical since the coating is subjected to after-treatment anyway and since too large a diameter is usually not so critical as too small a diameter, more specifically if the accumulated material forms at the expense of other regions of the coating so that the diameter must be re-finished to match this smaller diameter.

By contrast, the smoothing blade, which may trail in particular behind the wiping blade, is not intended to remove any material. Its main function is to uniformly spread the existing material and/or to slightly compress the material applied to cause it to flow and spread out. It can also be envisaged though that a smaller quantity of material be taken up by the smoothing blade and carried away. The smoothing blade can be moved together with the application blade or independently therefrom.

It is further possible to configure the smoothing blade over the entire length of the roller and to guide it over the entire length of the roller against said roller. This may for example be carried out with an oscillating movement.

The application blade can be limited by at least one collar that commences at the application blade and at the reservoir and forms a partial grip around the roller.

Material can thus accumulate to form a pool beneath which the roller rotates and from which it takes up the coating. Preferably, the distance between a respective one of the collars and the roller corresponds to the distance between the application blade and the roller. Inasmuch, the collars may be formed separately depending on the diameter of the roller and be replaceably fastened to the coating apparatus.

In particular the wiping blade, but the smoothing blade also, may be oriented vertically with respect to the direction of movement along which they are moved parallel to the axis of the shaft and may form a partial grip around the collar, in a manner similar to the collar. Moreover, and also irrespective of the other features of the invention, the application blade and/or the smoothing blade can be disposed on the roller at a distance that may vary with respect to the direction of movement of the coating apparatus. This distance may more specifically be such that the blade moves away from the roller in a direction counter to the direction of movement.

It is understood that such a coating apparatus is advantageous irrespective of the other features of the present invention in order to prevent beforehand irregularities, which result from irregular material supply, from uncontrollable flow processes, more particularly in the already coated region, and/or from displacement during curing and which have to be re-finished at high expense thereafter, from forming with coating apparatus that are displaceable along the roller axis or with spiral-shaped coating processes, in which the coating apparatus is for example fastened to a lathe cradle and is caused to move along the roller axis in synchronism with the rotation speed of the roller to be coated.

As an alternative or in addition thereto, the coating may be performed under vacuum or under anaerobic conditions in order to prevent air from becoming entrapped into the flowing material applied onto the roller during the coating process. It is understood that such a coating performed under vacuum or under anaerobic conditions or a coating apparatus disposed in a vacuum chamber is advantageous irrespective of the other features of the present invention in order to optimize the coating result obtained on a roller coated with curing plastic material.

In order to also coat the edges of a roller with a covering the quality of which corresponds to the quality of the remaining roller covering, it is proposed, as an alternative or in addition thereto, to first place a head on at least one side of the roller and to then coat both the head and the roller. Likewise, the arrangement for coating a roller with a covering may include at least one head that is placed onto one side of the roller and has the same diameter as the roller. After coating, the heads need only be removed and the roller including its side edges is coated with a uniform quality covering.

These removable heads are particularly suited for the application of epoxy resins or other fast curing multiple component coverings that are applied in a liquid state. With such an arrangement in particular, the coating can be applied progressively from one side to the roller to the other side of the roller as the roller is rotating, with little scrap, which is advantageous for fast curing materials. This application method can result in a spirally winding basic structure of the covering applied depending on the rotation speed of the roller and on the increasing speed of a corresponding application apparatus. This procedure is particularly advantageous for coverings in which air entrapped within the coating is critical since through such an application method the region of the liquid material coming into contact with air can be minimized. The head permits to provide an entrance and an exit zone respectively so that air bubbles or excess material or similar occurring during entrance or exit are not critical.

The head is preferably non-destructively removable so that it can be removed from the roller quickly and with little expense once the coating process is completed; in this context, the term “non-destructive” explicitly does not refer to the applied roller covering. It is understood that such a coating process including an attached and removable head and a corresponding coating apparatus are advantageous also irrespective of the other features of the present invention. The same applies to a coated roller the coating of which corresponds on at least one side, as far as its average quality is concerned, to the average quality of the remainder of the covering, this being realizable, according to present knowledge, with such a head only.

Instead of being applied in spiral windings, the coating may also be sprayed, spread, knife-coated or applied Each application may be done in spiral windings, meaning on a circumferential path, or over the roller width in one step. In the latter case, there may more specifically be provided a blade which extends over the entire length of the roller and by means of which the liquid component is applied onto the roller. It is understood that such a blade is advantageous irrespective of the other features of the present invention since a spiral structure, which could possibly impair the coating result, is not formed into the covering at all, more specifically if coating material scrap plays but a subordinate part. More specifically if diamond dust or dust with cubic boron nitride is used, spray application may be advantageous in order to obtain very thin layers so that the material accumulating on the respective dust to be found within the entire matrix volume over the thickness of the coating applied can be minimized as a result thereof.

### BRIEF DESCRIPTION OF THE DRAWING

Further advantages, objects and features of the present invention will be described herein after with reference to the attached drawing. In said drawing:

FIG. 1 is a schematic top view of a first coating apparatus;

FIG. 2 is a schematic top view of a first coating apparatus;

FIG. 3 is a schematic side view of two coating apparatus;

FIG. 4 is a coating arrangement with two removable heads and one roller to be coated;

FIG. 5 shows the beginning of the coating process on the arrangement of FIG. 4;

FIG. 6 shows the end of the coating process on the arrangement of FIG. 4; and

FIG. 7 shows the roller coated according to the FIGS. 4 through 6 and the removed heads.

### DETAILED DESCRIPTION OF PREFERRED EMBODIMENTS

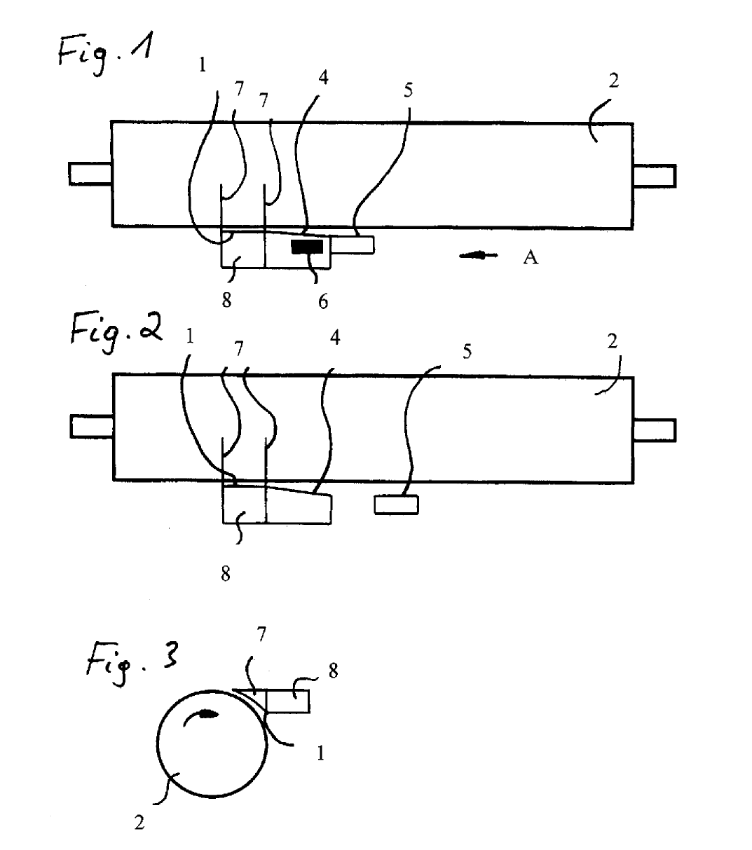

The coating apparatus illustrated in the FIGS. 1 through 3 each include one application blade 1 that is caused to move along a roller 2 in the direction pursuant to arrow A (see FIG. 1) in order to coat said roller with a liquid but curing coating 3 (see FIGS. 5 through 6).

The coating apparatus includes a wiping blade 4 trailing behind the application blade 1 and a smoothing blade 5 trailing behind the application blade 1, said blades being displaced accordingly. The smoothing blade 5 can be caused to move together with the application blade 1 (see embodiment according to FIG. 1) or independent therefrom (see embodiment according to FIG. 2). According to need, alternative embodiments may forgo the use of the smoothing blade or the wiping blade.

The trailing wiping blade 4 thereby permits on the one side to remove excess coating material and to spread it over other regions with less material. Excess material may moreover also be carried away, an overflow 6 being provided for this purpose in the embodiment in accordance with FIG. 1. The wiping blade 4 moves away from the roller 2 in a direction counter to its direction of movement so that the distance between the wiping blade 4 and the roller 2 progressively increases while the wiping blade 4 is guided along the roller 2. This increase may be gradual or continuous. Thus, material that possibly protrudes or accumulates through flowing or curing behind the application blade can still be wiped off and spread out again onto the roller or carried away through a possibly provided overflow 6.

The smoothing blade 5, by contrast, is not intended to remove any material. Its main function rather is to uniformly spread the existing material and/or to slightly compress the material applied to cause it to flow and spread out. It can also be envisaged though that a smaller quantity of material be taken up by the smoothing blade 5 and carried away.

The application blade 1 can be limited by at least one collar 7 that commences at the application blade 1 and at a reservoir 8 and forms a partial grip around the roller 2, as best shown in FIG. 3. Material can thus accumulate to form a pool beneath which the roller rotates and from which it takes the coating. In these exemplary embodiments, the distance between a respective one of the collars 7 and the roller 2 corresponds to the distance between the application blade 1 and the roller 2. Inasmuch, the collars 7 may be formed separately depending on the diameter of the roller and be replaceably fastened to the coating apparatus.

In an alternative that has not been illustrated herein but that is readily understandable, there is provided a continuous blade that is configured to extend over the entire length of the roller and is guided against the roller over the entire length thereof. This may for example be achieved by an oscillating movement that is more specifically parallel to the roller axis. Such a continuous blade can be readily employed as a smoothing blade only but it may also be used as an application and/or a wiping blade.

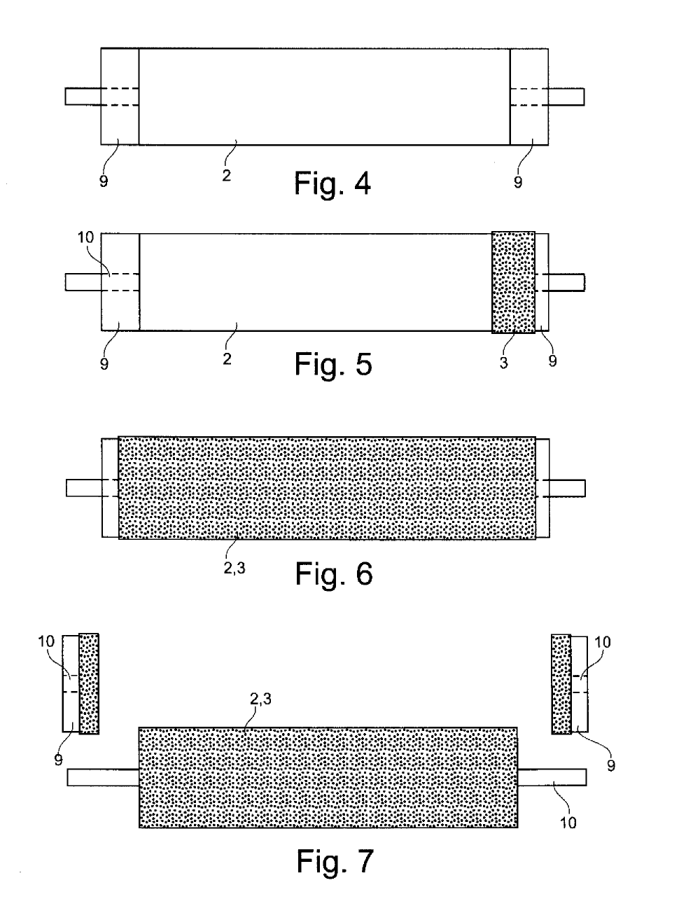

In order to also coat the edges of a roller 2 with a coating 3 the quality of which corresponds to the quality of the remaining roller coating, a head 9, the diameter of which matches the diameter of the roller, is formed on both sides of the roller 2. As outlined in the FIGS. 4 through 7 where they are only labelled by way of example, the heads 9 may comprise recesses 10 through which roller necks 11 (labelled by way of example only) protrude, the heads 9 on which the coating arrangement is rotatably carried being non-rotatably affixed beside the roller 2. On the other side, in an alternative embodiment, more specifically if the roller necks 11 are quite short, the heads may comprise necks of their own, which are turned away from the roller 2 and which rotatably carry the coating arrangement with recesses for the respective roller necks 11 being provided on the side turned toward the roller 2. If the roller has no necks but a central hole or lateral recesses, the heads may comprise complementary necks on the side turned toward the roller as well.

Both the heads 9 and the roller 2 may then be coated with such a coating arrangement. After coating, the heads 9 need only be removed as outlined in FIG. 7 and the roller is coated with a uniform quality covering up to its side edges.

An entrance and an exit zone respectively are provided by the heads 9 so that air bubbles or excess material or similar occurring during entrance or exit are not critical.

What is claimed is:

1. A roller with a coating comprised of a plastic matrix of plastic material, wherein the plastic material is a resin, wherein a surface of the coating has less than 50 pores per m², and wherein hard material particles are embedded in the plastic matrix.

2. The method of claim 1, wherein the plastic component is an epoxy resin.

3. The roller of claim 1, wherein the surface of the coating has less than 10 pores per m².

4. The roller of claim 1, wherein the hard material particles include diamond dust particles.

5. The roller of claim 1, wherein the hard material particles include cubic boron nitride particles.

6. The roller of claim 1, wherein the coating corresponds on at least one side, as far as its average quality is concerned, to the average quality of the remainder of the coating.

7. The roller of claim 1, wherein the coating has a basic structure spirally wound about the roller.
